(19) United States
(12) Patent Application Publication
(10) Pub. No.: US 2008/0023598 A1
(43) Pub. Date: Jan. 31, 2008

(54) ADJUSTABLE TILT SUPPORTING APPARATUS AND DISPLAY WITH THE SAME

(76) Inventors: CHUN-JUNG TSUO, Kweishan (TW); HAN-KUANG HO, Kweishan (TW)

Correspondence Address: HOFFMAN WARNICK & D'ALESSANDRO, LLC, 75 STATE STREET, 14TH FLOOR, ALBANY, NY, 12207, US

(21) Appl. No.: 11/781,368

(22) Filed: Jul. 23, 2007

(30) Foreign Application Priority Data
Jul. 28, 2006 (TW) 095127875
Jan. 19, 2007 (TW) 096102017

(51) Int. Cl. A47F 5/00; A47F 7/00; F16M 11/04

(52) U.S. Cl. 248/122.1; 248/176.3

(57) ABSTRACT

The invention is to provide an adjustable tilt supporting apparatus and an adjustably-tiltable display. In particular, the adjustable tilt supporting apparatus according to the invention replaces the function of traditional hinge with the use of surface friction, thus significantly reduces the use of metal for cost down purpose. Moreover, the adjustable tilt supporting apparatus according to the invention is also able to adjust the force of surface friction.

### BACKGROUND OF THE INVENTION

1. Field of the Invention

The invention relates to an adjustable tilt supporting apparatus and an adjustably-tiltable display. Particularly, the invention relates to an adjustable tilt supporting apparatus which replaces the function of traditional hinge with the use of surface friction, thus significantly reducing the consumption of metal for cost down purpose.

2. Description of the Prior Art

The structure of the current hinge assemblies for coupling an object with a base and letting the object pivot respective to the base are usually complicated. With the hinge assembly of prior art, the object is only provided with point friction at the two coupling points between the object and the base while pivoting respective to the base. The structure above-mentioned is not very strong or firm.

Besides, it is complicated to assemble the hinge assemblies in prior art. Moreover, the large consumption of metal imperceptibly increases the whole cost of manufacturing.

Accordingly, a scope of the present invention provides an adjustable tilt supporting apparatus and an adjustably-tiltable display to replace the function of traditional hinge with the use of surface friction, thus significantly reducing the consumption of metal for cost down purpose.

### SUMMARY OF THE INVENTION

According to one preferred embodiment, the adjustable tilt supporting apparatus of the invention includes a base, a shelf member, a supporting member, and a sliding member. The base has a first arc surface. The shelf member, capable of being mounted on the base, has a first end. The supporting member is pivotally mounted on the first end of the shelf member, and an object can be mounted on the supporting member. The sliding member, connected to the supporting member, has a first friction surface. The sliding member extends toward the base, and the first friction surface contacts the first arc surface. When the tilt of the object is adjusted, the supporting member rotates relative to the shelf member, and the first friction surface slides on the first arc surface so as to fix the tilt.

According to another preferred embodiment, the adjustably-tiltable display of the invention includes a screen, a base, a shelf member, a supporting member, and a sliding member. The base has a first arc surface. The shelf member, capable of being mounted on the base, has a first end. The supporting member, pivotally mounted on the first end of the shelf member, is capable of supporting the screen. The sliding member, connected to the supporting member, has a first friction surface. The sliding member extends toward the base, and the first friction surface contacts the first arc surface. When the tilt of the screen is adjusted, the supporting member rotates relative to the shelf member, and the first friction surface slides on the first arc surface so as to fix the tilt.

The advantage and spirit of the invention may be understood by the following recitations together with the appended drawings.

### BRIEF DESCRIPTION OF THE APPENDED DRAWINGS

FIG. 1 is a blown-up diagram of the adjustable tilt supporting apparatus according to a preferred embodiment of the invention.

FIG. 2 is a cross-sectional view of the adjustable tilt supporting apparatus in FIG. 1 along line A-A.

FIG. 3 is a partial view of a first preferred embodiment of the adjustable tilt supporting apparatus in FIG. 2 according to the invention.

FIG. 4 is a partial view of a second preferred embodiment of the adjustable tilt supporting apparatus in FIG. 2 according to the invention.

FIG. 5A is a partial view of a third preferred embodiment of the adjustable tilt supporting apparatus in FIG. 2 according to the invention.

FIG. 5B is a partial view of a fourth preferred embodiment of the adjustable tilt supporting apparatus in FIG. 2 according to the invention.

FIG. 6A is a partial view of a fifth preferred embodiment of the adjustable tilt supporting apparatus in FIG. 2 according to the invention.

FIG. 6B is a partial view of a sixth preferred embodiment of the adjustable tilt supporting apparatus in FIG. 2 according to the invention.

FIG. 7 is a free body diagram illustrating the adjustable tilt supporting apparatus thereon mounted an object according to a preferred embodiment of the invention.

FIG. 8A is a schematic diagram illustrating the adjustably-tiltable display leaning forward according to a preferred embodiment of the invention.

FIG. 8B is a schematic diagram illustrating the adjustably-tiltable display leaning backward according to a preferred embodiment of the invention.

### DETAILED DESCRIPTION OF THE INVENTION

The invention provides an adjustable tilt supporting apparatus and an adjustably-tiltable display. Particularly, the invention replaces the function of traditional hinge with the use of surface friction, thus significantly reducing the use of metal for cost down purpose. The preferred embodiments of the invention will be described in detail below, so as to well describe the features, the spirits, the advantages, and the easiness while actualizing of the invention.

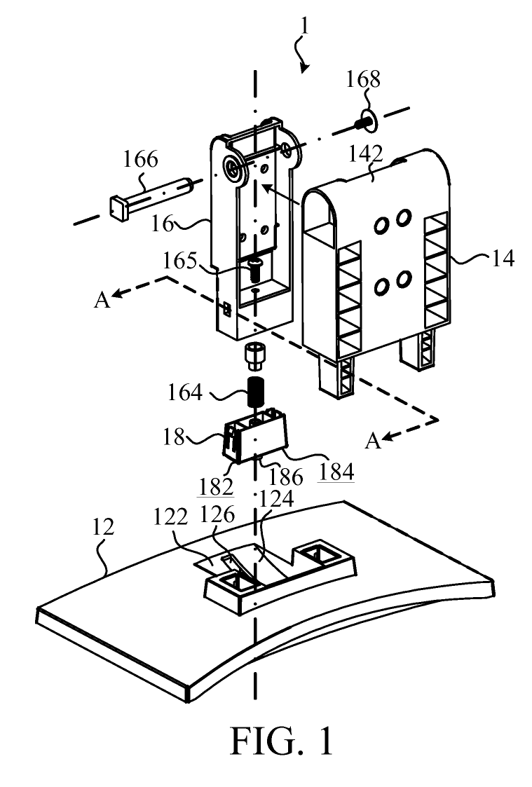

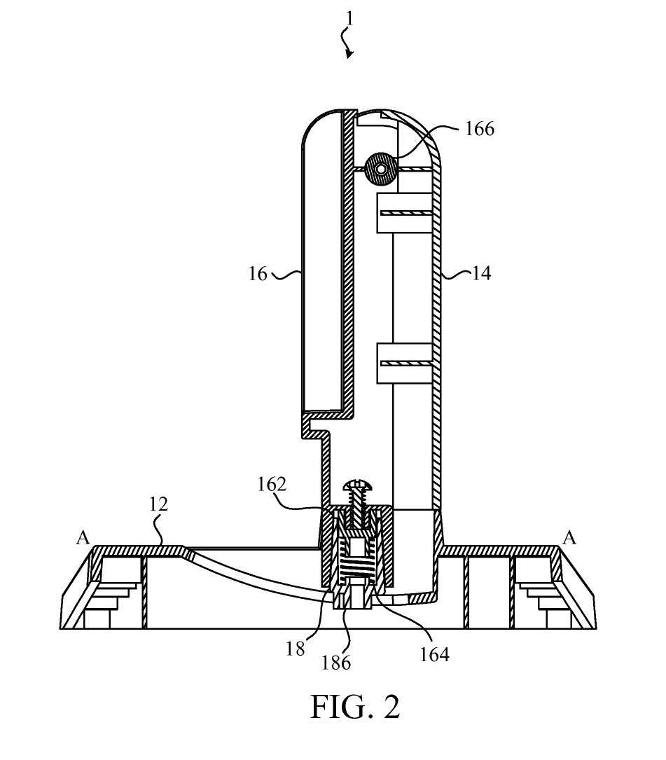

Referring to FIG. 1 and FIG. 2, FIG. 1 is a blown-up diagram of the adjustable tilt supporting apparatus 1 according to a preferred embodiment of the invention, and FIG. 2 is a cross-sectional view of the adjustable tilt supporting apparatus 1 in FIG. 1 along line A-A. As shown in FIG. 1 and FIG. 2, the adjustable tilt supporting apparatus 1 of the invention includes a base 12, a shelf member 14, a supporting member 16, and a sliding member 18. The base 12 has a first arc surface 122. The shelf member 14, capable of being mounted on the base 12, has a first end 142. The supporting member 16 is pivotally mounted on the first end 142 of the shelf member 14, and an object (not shown in FIG. 1 and FIG. 2) can be mounted on the supporting member 16. The sliding member 18, connected to the supporting member 16, has a first friction surface 182. The sliding member 18 extends toward the base 12, and the first friction surface 182 contacts the first arc surface 122.

In an embodiment, a way for pivotally mounting the supporting member 16 to the first end 142 of the shelf member 14 is to assemble a shaft 166 and a screw 168. As shown in FIG. 1, when the tilt of the object is adjusted, the supporting member 16 rotates relative to the shelf member 14, and the first friction surface 182 slides on the first arc surface 122 so as to fix the tilt of the object.

In an embodiment, the base 12 has a second arc surface 124; the sliding member 18 has a second friction surface 184 which contacts the second arc surface 124. During rotation of the supporting member 16 relative to the shelf member 14, the second friction surface 184 of the sliding member 18 slides on the second arc surface 124.

In an embodiment, the base 12 thereon provides a groove 126 which is formed between the first arc surface 122 and the second arc surface 124. The sliding member 18 includes a protrusion 186 which extends toward to the base 12 and is limitedly movably disposed in the groove 126.

As shown in FIG. 2, the supporting member 16 has a bottom end which is formed into a container structure 162; the sliding member 18 is movably retained in the container structure 162. The adjustable tilt supporting apparatus 1 further includes a resilient member 164 which is compressed between the supporting member 16 and the sliding member 18.

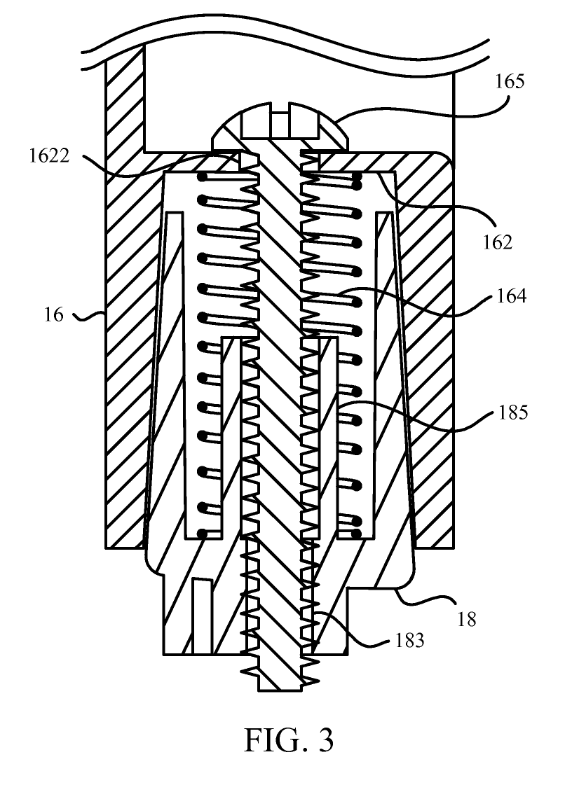

Referring to FIG. 3, FIG. 3 is a partial view of a first preferred embodiment of the adjustable tilt supporting apparatus 1 in FIG. 2 according to the invention. As shown in FIG. 3, the sliding member 18 has a screw hole 183, the top of the container structure 162 has an aperture 1622, and the adjustable tilt supporting apparatus 1 further includes a screw 165. The screw 165, adapted to the screw hole 183 that is formed on the sliding member 18, passes through the aperture 1622 and the resilient member 164 to screw into the screw hole 183, such that the compression of the resilient member 164 is adjusted by the screw 165. After the compression of the resilient member 164 is adjusted by the screw 165, the frictional force, which the sliding member 18 applies to the base 12, simultaneously changes. Hence, users are able to adjust the adjustable tilt supporting apparatus 1 in accordance with the adjusting force they want.

Besides, in the embodiment, it is notable that the resilient member 164 is compressed between the supporting member 16 and the sliding member 18. After the screw 165 passes through the aperture 1622 to rotate downward into the screw hole 183, and the head of the screw 165 contacts the aperture 1622, the motion of rotating of the screw 165 makes the sliding member 18 directly move upward along the thread of the screw 165, such that the compression of the resilient member 164 is increased. However, the frictional force that the sliding member 18 applies to the base 12 is decreased. In contrast, when the screw 165 rotates out of the screw hole 183, the sliding member 18 will directly move downward along the thread of the screw 165, such that the compression of the resilient member 164 is decreased. However, the frictional force that the sliding member 18 applies to the base 12 is increased.

As shown in FIG. 3, the sliding member 18 has a jacket 185 extending from the screw hole 183 toward the aperture 1622 of the container structure 162. The resilient member 164 surrounds the periphery of the jacket 185. The screw 165 is locked into the screw hole 183 by passing through the aperture 1622, the resilient member 164, and the jacket 185.

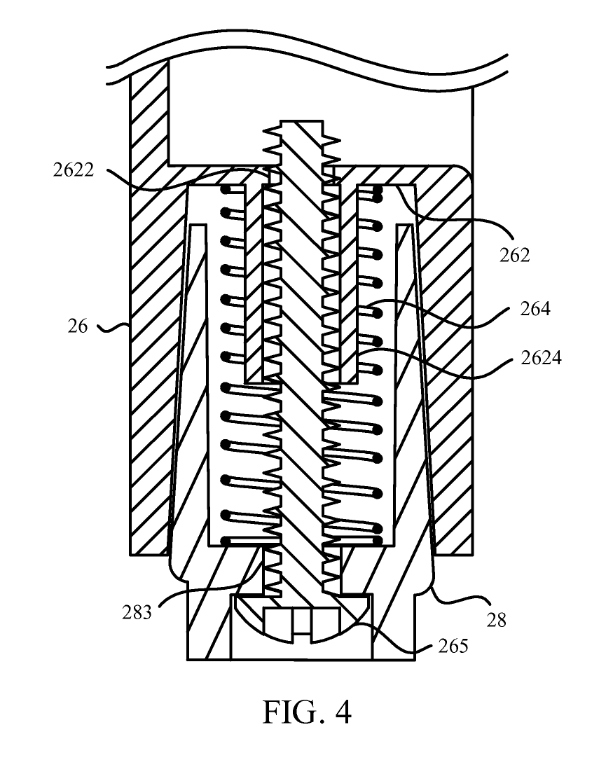

Referring to FIG. 4, FIG. 4 is a partial view of a second preferred embodiment of the adjustable tilt supporting apparatus 1 in FIG. 2 according to the invention. As shown in FIG. 4, the top portion of the container structure 262 has a screw hole 2622, the bottom portion of the sliding member 28 has an aperture 283, and the adjustable tilt supporting apparatus 1 further includes a screw 265. The screw 265, adapted to the screw hole 2622 which is formed on the container structure 262, passes through the aperture 283 and the resilient member 264 to lock into the screw hole 2622, such that the compression of the resilient member 264 is adjusted by the screw 265. After the compression of the resilient member 264 is adjusted by the screw 265, the frictional force that the sliding member 28 applies to the base 12 simultaneously changes.

Similarly, in the embodiment, it is notable that the resilient member 264 is compressed between the supporting member 26 and the sliding member 28. After the screw 265 passes through the aperture 283 to rotate upward into the screw hole 2622, and the head of the screw 265 contacts the aperture 283, the motion of rotating of the screw 265 makes the sliding member 28 directly move upward along the thread of the screw 265, such that the compression of the resilient member 264 is increased. However, the frictional force that the sliding member 28 applies to the base 12 is decreased. In contrast, when the screw 265 rotates out of the screw hole 2622, the sliding member 28 will directly move downward along the thread of the screw 265, such that the compression of the resilient member 264 is decreased. However, the frictional force that the sliding member 28 applies to the base 12 is increased.

As shown in FIG. 4, the container structure 262 has a jacket 2624 extending from the screw hole 2622 toward the aperture 283 of the sliding member 28. The resilient member 264 surrounds the periphery of the jacket 2624. The screw 265 passes through the aperture 283, the resilient member 264, and the jacket 2624 to lock into the screw hole 2622.

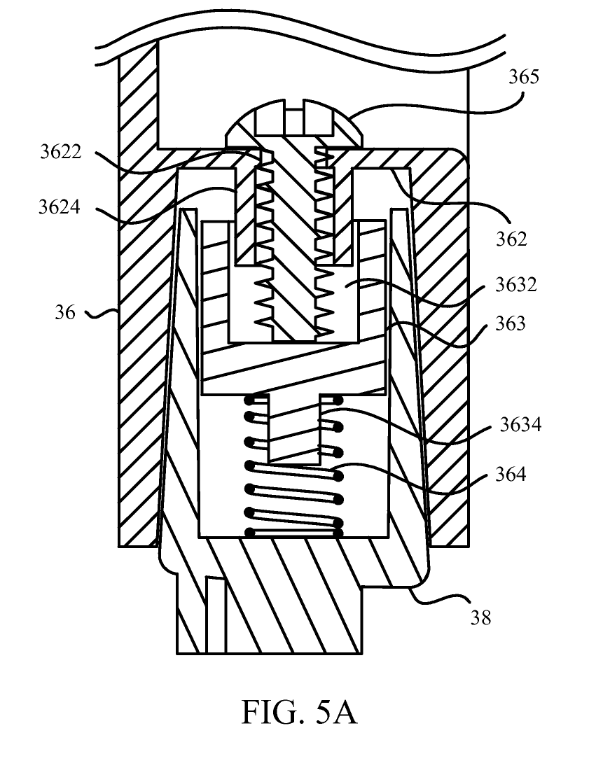

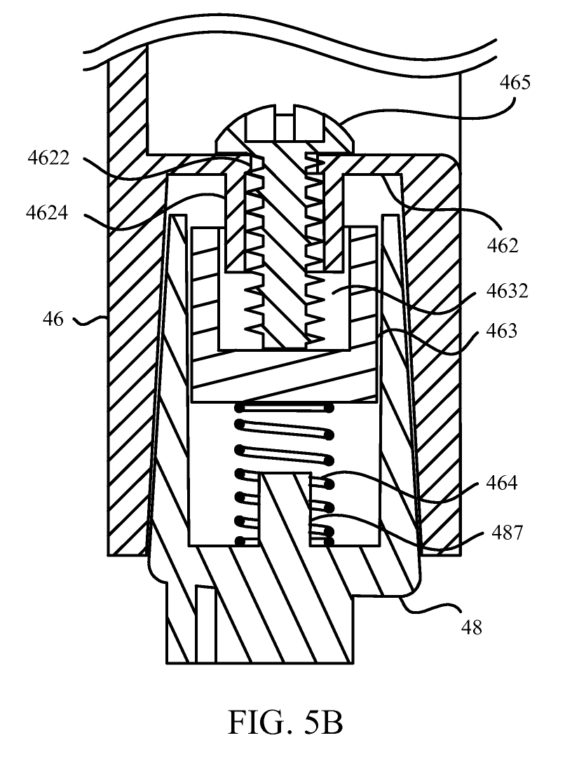

Referring to FIG. 5A, FIG. 5A is a partial view of a third preferred embodiment of the adjustable tilt supporting apparatus 1 in FIG. 2 according to the invention. As shown in FIG. 5A, the top portion of the container structure 362 has a screw hole 3622, and the adjustable tilt supporting apparatus 1 further includes a block 363 and a screw 365. The resilient member 364 is disposed between the sliding member 38 and the block 363. The screw 365, adapted to the screw hole 3622 which is formed on the container structure 362, is locked into the screw hole 3622 to press against the block 363, such that the compression of the resilient member 364 is adjusted by the screw 365. After the compression of the resilient member 364 is adjusted by the screw 365, the frictional force that the sliding member 38 applies to the base 12 simultaneously changes.

As shown in FIG. 5A, in an embodiment, the periphery of the block 363 is adapted to the structure of the sliding member 38, so as to be movably retained in the sliding member 38.

As shown in FIG. 5A, the top portion of the block 363 has a recess 3632. The distal end of the screw 365 presses against the block 363, and the screw 365 is accommodated in the recess 3632 for preventing the lateral movement of the block 363. Furthermore, in the embodiment, the top portion of the container structure 362 has a jacket 3624 which substantially extends from the screw hole 3622 toward the sliding member 38 and is adapted to the recess 3632.

Also shown in FIG. 5A, the bottom portion of the block 363 has a boss 3634 which passes through the resilient member 364 from top to bottom for preventing the lateral movement of the resilient member 364.

Referring to FIG. 5B, FIG. 5B is a partial view of a fourth preferred embodiment of the adjustable tilt supporting apparatus 1 in FIG. 2 according to the invention. As shown in FIG. 5B, the top portion of the container structure 462 has a screw hole 4622, the adjustable tilt supporting apparatus 1 further includes a block 463 and a screw 465. The resilient member 464 is disposed between the sliding member 48 and the block 463. The screw 465, adapted to the screw hole 4622, which is formed on the container structure 462, is locked into the screw hole 4622 to press against the block 463, such that the compression of the resilient member 464 is adjusted by the screw 465. After the compression of the resilient member 464 is adjusted by the screw 465, the frictional force that the sliding member 48 applies to the base 12 simultaneously changes.

As shown in FIG. 5B, the top portion of the block 463 has a recess 4632. The distal end of the screw 465 presses against the block 463, and the screw 465 is accommodated in the recess 4632 for preventing the lateral movement of the block 463. Furthermore, in the embodiment, the top portion of the container structure 462 has a jacket 4624 which substantially extends from the screw hole 4622 toward the sliding member 48 and is adapted to the recess 4632.

Also shown in FIG. 5B, the bottom portion of the sliding member 48 has a boss 487, which passes through the resilient member 464 from bottom to top, for preventing the lateral movement of the resilient member 464.

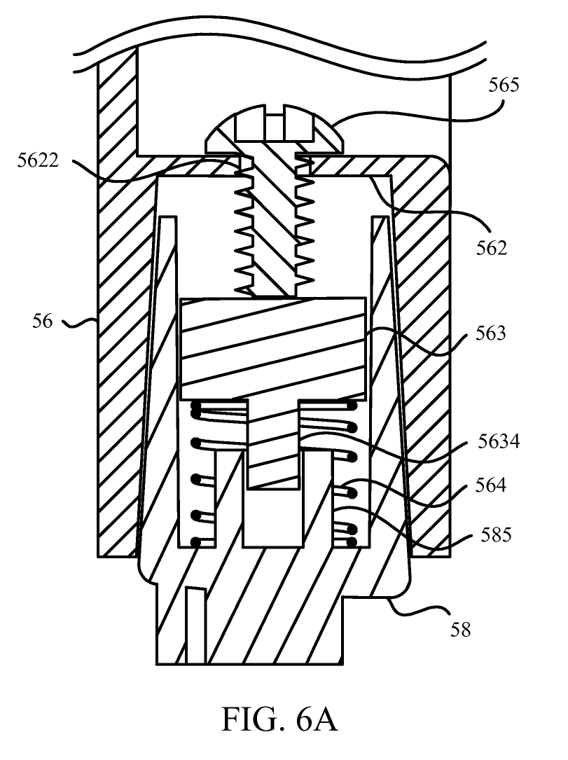

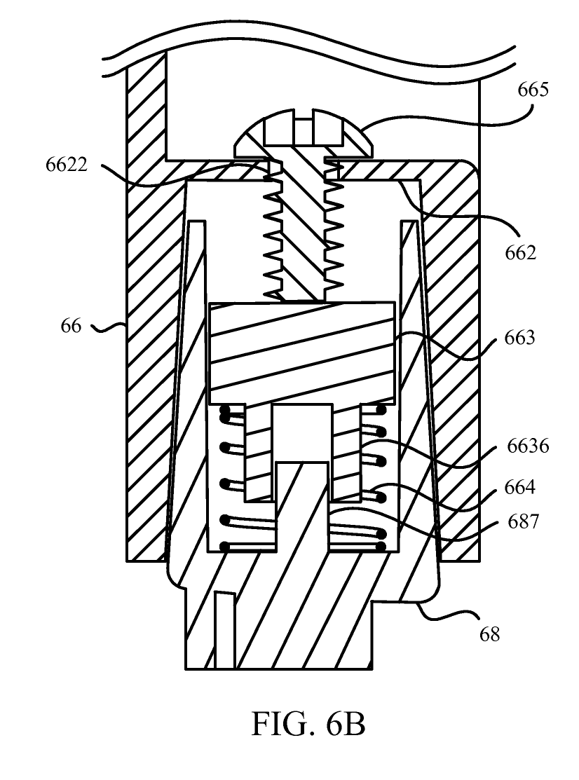

Referring to FIG. 6A, FIG. 6A is a partial view of a fifth preferred embodiment of the adjustable tilt supporting apparatus 1 in FIG. 2 according to the invention. As shown in FIG. 6A, the top portion of the container structure 562 has a screw hole 5622, and the adjustable tilt supporting apparatus 1 further includes a block 563 and a screw 565. The resilient member 564 is disposed between the sliding member 58 and the block 563. The screw 565, adapted to the screw hole 5622 which is formed on the container structure 562, is locked into the screw hole 5622 to press against the block 563, such that the compression of the resilient member 564 is adjusted by the screw 565. After the compression of the resilient member 564 is adjusted by the screw 565, the frictional force that the sliding member 58 applies to the base 12 simultaneously changes.

As shown in FIG. 6A, the bottom portion of the block 563 has a boss 5634, which passes through the resilient member 564 from top to bottom, for preventing the lateral movement of the resilient member 564.

Also shown in FIG. 6A, the bottom portion of the sliding member 58 has a jacket 585, which substantially extends toward the container structure 562, and is adapted to the boss 5634. The size of the resilient member 564 is adapted to the periphery of the jacket 585 or is to be retained between the boss 5634 and the jacket 585.

Referring to FIG. 6B, FIG. 6B is a partial view of a sixth preferred embodiment of the adjustable tilt supporting apparatus 1 in FIG. 2 according to the invention. As shown in FIG. 6B, the top portion of the container structure 662 has a screw hole 6622, and the adjustable tilt supporting apparatus 1 further includes a block 663 and a screw 665. The resilient member 664 is disposed between the sliding member 68 and the block 663. The screw 665, adapted to the screw hole 6622 which is formed on the container structure 662, is locked into the screw hole 6622 to press against the block 663, such that the compression of the resilient member 664 is adjusted by the screw 665. After the compression of the resilient member 664 is adjusted by the screw 665, the frictional force that the sliding member 68 applies to the base 12 simultaneously changes.

As shown in FIG. 6B, the bottom portion of the sliding member 68 has a boss 687 which passes through the resilient member 664 from bottom to top for preventing the lateral movement of the resilient member 664.

Also shown in FIG. 6B, the block 663 has a jacket 6636 which substantially extends toward the sliding member 68 and is adapted to the boss 687. The size of the resilient member 664 is adapted to the periphery of the jacket 6636 or is to be retained between the boss 687 and the jacket 6636.

In an embodiment, the resilient member 164 is a spring.

Furthermore, in an embodiment, in order to reduce the consumption of metal, the base 12, shelf member 14, the supporting member 16, and the sliding member 18 are formed of a polymer material. The sliding member 18 can be made of nylon, and the material of the base 12, the shelf member 14, and the supporting member 16 can be a specific thermal composite material, such as Acrylonitrile Butadiene Styrene Copolymer. Therefore, the consumption of metal can be significantly decreased to reduce the cost of manufacturing.

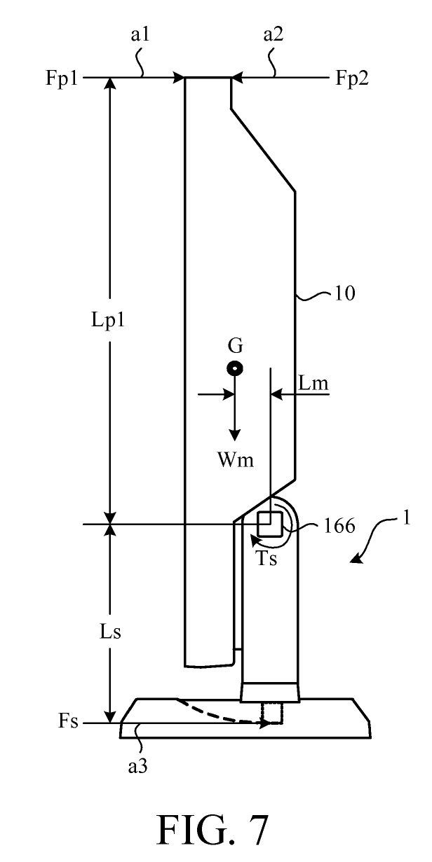

Referring to FIG. 7, FIG. 7 is a free body diagram illustrating the adjustable tilt supporting apparatus 1 thereon mounted an object 10 according to a preferred embodiment of the invention. As shown in FIG. 7, the object 10 has a center of gravity G. The center of gravity G causes the force Fp1, with which the object 10 is forced to lean forward (as the direction a1 shown in FIG. 7) to be different from the force Fp2, with which the object 10 is forced to lean backward (as the direction a2 shown in FIG. 7). In order not to feel uncomfortable because of the difference in the adjusting force while adjusting the object 10, a torsion spring (not shown in FIG. 7) can be installed at the shaft 166 for balancing the force Fp1 and the force Fp2. The balancing formulas are expressed as formula 1 and formula 2.

Fp1*Lp1+Ts=Fs*Ls+Wm*Lm=>Fp1=(Fs*Ls+Wm*Lm−Ts)/Lp1 Formula 1:

Fp2*Lp1+Wm*Lm−Ts=Fs*Ls=>Fp2=(Fs*Ls−Wm*Lm+Ts)/Lp1 Formula 2:

If Wm*Lm=Ts

=>Fp1=Fp2

Wherein Lp1 is the moment arm of the force Fp1 and Fp2 respective to the shaft 166; Fs is the surface frictional force between the sliding member 18 and the arc surface 122 and 124, and the direction of Fs is as the direction a3 shown in FIG. 7; Ls is the moment arm of Fs respective to the shaft 166. The above-mentioned torsion spring (not shown in FIG. 7) is able to provide torque Ts. In an embodiment, the torsion spring has a first arm and a second arm (not shown in FIG. 7). The first arm is engaged to the supporting member 16, and the second arm is engaged to the shelf member 14.

Therefore, according to the adjustable tilt supporting apparatus 1 of a preferred embodiment of the invention, which has an object 10 mounted thereon, users will not feel uncomfortable because of the difference in the adjusting force while adjusting the object 10.

Moreover, in an embodiment, in order to reduce the volume occupied by packaging, the shelf member 14 can be detachably fixed on the base 12.

In an embodiment, the object 10 can be a screen (or a monitor), a photo frame, a clock . . . etc.

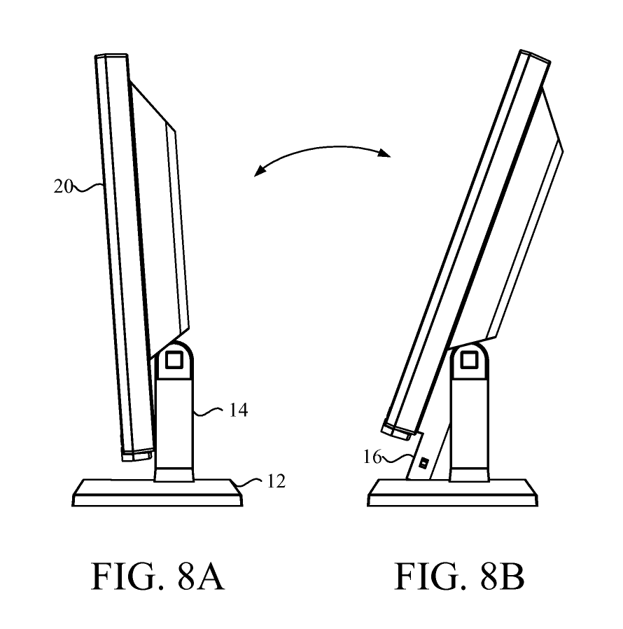

Referring to FIG. 8A and FIG. 8B, FIG. 8A is a schematic diagram illustrating the adjustably-tiltable display 2 leaning forward according to a preferred embodiment of the invention; FIG. 8B is a schematic diagram illustrating the adjustably-tiltable display 2 leaning backward according to a preferred embodiment of the invention. According to another preferred embodiment of the invention, the adjustably-tiltable display 2 applies in the same way as the adjustable tilt supporting apparatus 1 shown in FIG. 1. The structure of the adjustable tilt supporting apparatus 1 can be referred to in FIG. 1 and the respective explanations. As shown in FIG. 8A and FIG. 8B, it is notable that the object 10 can be the screen 20 of the adjustably-tiltable display 2. While adjusting the tilt of the screen 20, the supporting member 16 rotates respective to the shelf member 14, and the first friction surface 182 moves on the first arc surface 122 so as to fix the tilt of the screen 20.

In an embodiment, the base 12 has a second arc surface 124; the sliding member 18 has a second friction surface 184 which contacts the second arc surface 124. During rotation of the supporting member 16 relative to the shelf member 14, the second friction surface 184 of the sliding member 18 slides on the second arc surface 124.

In an embodiment, the base 12 thereon provides a groove 126 which is formed between the first arc surface 122 and the second arc surface 124. The sliding member 18 includes a protrusion 186 which extends from and is limitedly movably disposed in the groove 126.

In an embodiment, the supporting member 16 has a bottom end which is formed into a container structure 162; the sliding member 18 is movably retained in the container structure 162. The adjustable tilt supporting apparatus 1 further includes a resilient member 164 which is compressed between the supporting member 16 and the sliding member 18.

With the detail descriptions above about the preferred embodiments of the invention, it is obvious that according to the adjustable tilt supporting apparatus and the adjustably-tiltable display of the invention, the function of traditional hinge is replaced by using surface friction, and the consumption of metal is significantly reduced for cost down purpose. Moreover, the adjustable tilt supporting apparatus according to the invention also can adjust the force of surface friction.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. An adjustable tilt supporting apparatus being capable of supporting an object, the adjustable tilt supporting apparatus comprising:
a base having a first arc surface;
a shelf member, capable of being mounted on the base, having a first end;
a supporting member, pivotally mounted on the first end of the shelf member, the object being capable of being mounted on the supporting member; and
a sliding member, connected to the supporting member, having a first friction surface, the sliding member extending toward the base, and the first friction surface contacting the first arc surface;
wherein when the tilt of the object is adjusted, the supporting member rotates relative to the shelf member and the first friction surface slides on the first arc surface so as to fix the tilt.

2. The adjustable tilt supporting apparatus of claim 1, wherein the base has a second arc surface, the sliding member has a second friction surface contacting the second arc surface, and during rotation of the supporting member relative to the shelf member, the second friction surface of the sliding member slides on the second arc surface.

3. The adjustable tilt supporting apparatus of claim 2, wherein the base thereon provides a groove formed between the first arc surface and the second arc surface, and the sliding member comprises a protrusion that extends toward the base and is limitedly movably disposed in the groove.

4. The adjustable tilt supporting apparatus of claim 1, wherein the supporting member has a bottom end formed into a container structure, the sliding member is movably retained in the container structure, and the adjustable tilt supporting apparatus further comprises a resilient member compressed between the supporting member and the sliding member.

5. The adjustable tilt supporting apparatus of claim 4, wherein the sliding member has a screw hole, the container structure has an aperture, and the adjustable tilt supporting apparatus further comprises:
a screw, adapted to the screw hole which is formed on the sliding member, passing through the aperture and the resilient member to lock into the screw hole, such that the compression of the resilient member is adjusted by the screw.

6. The adjustable tilt supporting apparatus of claim 5, wherein the sliding member has a jacket extending from the screw hole toward the container structure, the resilient member surrounds the periphery of the jacket, and the screw passes through the aperture, the resilient member, and the jacket.

7. The adjustable tilt supporting apparatus of claim 4, wherein the container structure has a screw hole, the sliding member has an aperture, and the adjustable tilt supporting apparatus further comprises:
a screw, adapted to the screw hole which is formed on the container structure, passing through the aperture and the resilient member to be locked into the screw hole, such that the compression of the resilient member is adjusted by the screw.

8. The adjustable tilt supporting apparatus of claim 7, wherein the container structure has a jacket extending from the screw hole toward the sliding member, the resilient member surrounds the periphery of the jacket, and the screw locked into the screw hole by passing through the aperture, the resilient member, and the jacket.

9. The adjustable tilt supporting apparatus of claim 4, wherein the container structure has a screw hole, the adjustable tilt supporting apparatus further comprises:
a block, the resilient member disposed between the sliding member and the block; and
a screw, adapted to the screw hole which is formed on the container structure, locked into the screw hole to press against the block, such that the compression of the resilient member is adjusted by the screw.

10. The adjustable tilt supporting apparatus of claim 9, wherein the periphery of the block is adapted to the structure of the sliding member to be movably retained in the sliding member.

11. The adjustable tilt supporting apparatus of claim 9, wherein the block has a recess, the distal end of the screw presses against the block, and the screw is accommodated in the recess for preventing the lateral movement of the block.

12. The adjustable tilt supporting apparatus of claim 11, wherein the container structure has a jacket which extends from the screw hole toward the sliding member and is adapted to the recess.

13. The adjustable tilt supporting apparatus of claim 9, wherein the block has a boss which passes through the resilient member for preventing the lateral movement of the resilient member.

14. The adjustable tilt supporting apparatus of claim 13, wherein the sliding member has a jacket which extends toward the container structure and is adapted to the boss, the size of the resilient member is adapted to the periphery of the jacket or retained between the boss and the jacket.

15. The adjustable tilt supporting apparatus of claim 9, wherein the sliding member has a boss which passes through the resilient member for preventing the lateral movement of the resilient member.

16. The adjustable tilt supporting apparatus of claim 15, wherein the block has a jacket which extends toward the sliding member and is adapted to the boss, the size of the resilient member is adapted to the periphery of the jacket or retained between the boss and the jacket.

17. The adjustable tilt supporting apparatus of claim 4, wherein the resilient member is a spring.

18. The adjustable tilt supporting apparatus of claim 1, wherein the base, shelf member, the supporting member, and the sliding member are formed of a polymer material.

19. The adjustable tilt supporting apparatus of claim 1, further comprising a torsion spring having a first arm engaged to the supporting member and a second arm engaged to the shelf member.

20. An adjustably-tiltable display, comprising:
a screen;
a base having a first arc surface;
a shelf member, capable of being mounted on the base, having a first end;
a supporting member, pivotally mounted on the first end of the shelf member, being capable of supporting the screen; and
a sliding member, connected to the supporting member, having a first friction surface, the sliding member extending toward the base, and the first friction surface contacting the first arc surface;
wherein when the tilt of the screen is adjusted, the supporting member rotates relative to the shelf member, and the first friction surface slides on the first arc surface so as to fix the tilt of the screen.

21. The adjustably-tiltable display of claim 20, wherein the base has a second arc surface, the sliding member has a second friction surface contacting the second arc surface, and during rotation of the supporting member relative to the shelf member, the second friction surface of the sliding member slides on the second arc surface.

22. The adjustably-tiltable display of claim 21, wherein the base thereon provides a groove formed between the first arc surface and the second arc surface, and the sliding member comprises a protrusion that extends toward to the base and is limitedly movably disposed in the groove.

23. The adjustably-tiltable display of claim 20, wherein the supporting member has a bottom end formed a container structure, the sliding member is movably retained in the container structure, and the adjustably-tiltable display further comprises a resilient member compressed between the supporting member and the sliding member.

24. The adjustably-tiltable display of claim 23, wherein the sliding member has a screw hole, the container structure has an aperture, and the adjustably-tiltable display further comprises:
a screw, adapted to the screw hole which is formed on the sliding member, passing through the aperture and the resilient member to be locked into the screw hole, such that the compression of the resilient member is adjusted by the screw.

25. The adjustably-tiltable display of claim 23, wherein the container structure has a screw hole, the sliding member has an aperture, and the adjustably-tiltable display further comprises:
a screw, adapted to the screw hole which is formed on the container structure, passing through the aperture and the resilient member to be lock into the screw hole, such that the compression of the resilient member is adjusted by the screw.

26. The adjustably-tiltable display of claim 23, wherein the container structure has a screw hole, the adjustably-tiltable display further comprises:
a block, the resilient member disposed between the sliding member and the block; and
a screw, adapted to the screw hole which is formed on the container structure, locked into the screw hole to press against the block, such that the compression of the resilient member is adjusted by the screw.

27. The adjustably-tiltable display of claim 26, wherein the periphery of the block is adapted to the structure of the sliding member to be movably retained in the sliding member.

28. The adjustably-tiltable display of claim 26, wherein the block has a recess, the distal end of the screw presses against the block, and the screw is accommodated in the recess for preventing the lateral movement of the block.

29. The adjustably-tiltable display of claim 26, wherein the block has a boss which passes through the resilient member for preventing the lateral movement of the resilient member.

30. The adjustably-tiltable display of claim 26, wherein the sliding member has a boss which passes through the resilient member for preventing the lateral movement of the resilient member.

31. The adjustably-tiltable display of claim 20, further comprising a torsion spring having a first arm engaged to the supporting member and a second arm engaged to the shelf member.
